(19) United States
(12) Patent Application Publication
(10) Pub. No.: US 2009/0300508 A1
(43) Pub. Date: Dec. 3, 2009

(54) METADATA-BASED ENTERTAINMENT CONTENT SELECTION

(76) Inventors: Steven Krampf, Chestnut Hill, MA (US); Evan B. Ross, (US)

Correspondence Address: WOLF GREENFIELD & SACKS, P.C., 600 ATLANTIC AVENUE, BOSTON, MA, 02210-2206, US

(21) Appl. No.: 12/419,868

(22) Filed: Apr. 7, 2009

Related U.S. Application Data
(63) Continuation-in-part of application No. 11/967,692, filed on Dec. 31, 2007.
Application No. 11/967,692 is a continuation-in-part of application No. 11/260,699, filed on Oct. 27, 2005.
(60) Provisional application No. 60/623,006, filed on Oct. 27, 2004.
(60) Provisional application No. 60/622,924, filed on Oct. 27, 2004.
(60) Provisional application No. 60/637,669, filed on Dec. 20, 2004.
(60) Provisional application No. 60/708,673, filed on Aug. 16, 2005.

(51) Int. Cl. G06F 17/30; G06F 3/048; G06F 15/16

(52) U.S. Cl. 715/739; 707/10; 707/E17.032

(57) ABSTRACT

A method of accessing content stored on a digital media content storage device on which one or more content records contain metadata defining media content on the device, comprising downloading from the device to a controller unit at least some of said metadata, storing said downloaded metadata in a database accessible to the controller, and accessing content on the storage device from the controller using the database of downloaded metadata.

### RELATED APPLICATIONS

This application is a continuation-in-part of U.S. Ser. No. 11/967692, titled “ENTERTAINMENT SYSTEM WITH UNIFIED CONTENT SELECTION,” filed Dec. 31, 2007, which is a continuation-in-part of U.S. Ser. No. 11/260699, titled “Entertainment System with Bandless Tuning, Remote Control, Alarm and Universal Docking,” filed Oct. 27, 2005, which in turn claims priority under 35 USC 119(e) to the following U.S. Provisional Applications: Ser. Nos. 60/623006 and 60/622,924, both filed on Oct. 27, 2004, and 60/637,669, filed Dec. 20, 2004, all titled “APPARATUS FOR AUDIO PLAYBACK AND METHODS OF USING SAME” and Serial No. 60/708,673, filed Aug. 16, 2005 and titled “DUAL-MODE WIRED/WIRELESS REMOTE CONTROL AND ENTERTAINMENT UNIT USING SAME,” each of which is hereby incorporated by reference.

### FIELD OF INVENTION

This invention relates to the field of electronic entertainment systems and, in particular, to a system which includes a wireless control unit for accessing media content from a local or remote server by downloading from the server metadata permitting a database of server content to be developed and used to control the server.

### BACKGROUND

Electronic entertainment systems are not, as a category, new. Radios, for example, have delivered audio content for more than 75 years. Phonographs have existed for more than 100 years. They have evolved into numerous other pertinent devices which may stand alone or include radio receivers, including (without limitation) removable media tape, CD players and DVD, satellite broadcast receivers and various kinds of fixed-media players such as MP3 players (any of which may be stationary, portable or mobile e.g., in an automobile or other vehicle). The latter include, for example, various models of the iPod brand of portable music players from Apple Computer, Inc. of Cupertino, Calif., the Zen and other players from Creative Technology, Ltd. of Singapore, and so forth.

Some manufacturers have provided base units into which certain specific portable music players of a single manufacturer, such as Apple Computer's iPod players, may be docked to play music recorded on the player via amplifiers and speakers external to the player. A portable digital music player may not only serve as a content source for a loudspeaker(s) via an amplifier (stand alone or in a radio), but also it may serve up music (or other) content via a network, when connected to a base unit which is equipped with a network interface. When such a portable music player is coupled to a radio or to an external amplifier and speaker system, typically for full control the player must be accessed via its native, or on-board user interface and controls. This is often inconvenient, however, as the player must be left connected in a fixed location and the user may wish to sit some distance away, or to move around. Thus, there is an added complication: that of providing remote control of the device. With users often having thousands of songs, instrumental selections or other musical or audio content (hereafter, generally denoted as “songs” irrespective of the nature of the music or other audible content) stored on such a device, there is a considerable challenge to providing remote selection of content while minimizing latency in the process. User satisfaction is closely related to how quickly and easily content may be selected. With current approaches by others, it may typically take what feels like either a long time for a user to be able to select a song remotely from a player connected to a base unit or the user has to get up from his or her place of comfort and walk over to the base unit to access the interface on the player itself. A user can “jump” from song to song but may not choose a song through an alphanumeric selection input. Neither does a user see on a screen of a handheld remote control a display of a song selection interface screen. We have determined that this relatively slow performance is not well received by potential customers, and that with a large database of songs users would prefer navigation that is as close to instantaneous as possible.

Accordingly, faster and more flexible access to the content of a portable digital music player is desired.

Such content need not be limited to music content, of course. The same issues exist when the content is video content, multimedia content, or some other and perhaps yet-to-be-developed form of entertainment/media content. Moreover, while the server of such content may be a portable digital player device, the same interfacing and content access issues are present if the server is a fixed local device or a remote device accessed via a network (which may be a local or wide-area network, a combination thereof, wired, wireless or a combination), Indeed, networking issues aggravate the concerns about latency.

Thus, in general, improved user interfaces for home and auto entertainment systems are needed.

### SUMMARY OF INVENTION

Various efforts to integrate bits and pieces of the media landscape into a cohesive and affordable system have been met with problems such as, for example, incompatibility of various devices, proprietary frequencies and protocols, inelegant user integration, slow content access times or even high price. The system presented herein provides for more convenient and easier to use hosting for the large number of existing media products, adaptability to future products, and a better user experience for the consumer. Networking circumstances are supported to deliver media content, and digital players may be used as a source of entertainment content with rapid accessibility to content selections. There is shown a system for in-home or in-office use, and some aspects for automobile use, which can serve up media content from numerous storage, playback or broadcast sources, including digital media players, network sources, terrestrial broadcast stations, and satellites along with switchless tuning and a simplified, unified treatment of content sources. Some aspects or features may be useful for portable devices, as well, while others likely will not.

Entertainment systems as presented herein address the above-expressed needs and others that will become apparent below. An integrated collection of components, features and techniques together provide improved delivery of (typically, audio, video or multimedia—e.g., audio-visual) content and improved, simplified control over the delivery and selection of that content, and related functionality. There are various aspects to the system, and related methods as discussed below.

According to a first aspect, an entertainment system is shown, comprising a base unit having electronics including a transceiver for interacting, at least at times, with a control unit via a communications link that is preferably an RF link, and a control unit for controlling the base unit, the control unit preferably being dockable with the base unit to establish direct electrical connection therebetween and including a transceiver for interacting with the control unit via said RF link when undocked from the base unit to become portable. The control unit is thus operable in two modes and presents substantially the same user experience in both modes. The control unit may be considered a separate aspect of the invention or system.

The base unit may contain a radio tuner, preferably with unified tuning capability (see below), and may be designed to receive media content from various sources such as a portable music (e.g., MP3) player, terrestrial radio tuners (e.g., AM, FM, HD), satellite receivers, wireless networking cards (e.g., to access streaming media or to deliver up to others music or other media content from a docked portable player), and so forth. The radio tuner(s) and/or other sources may supply a stream of information (continuously or intermittently) from a broadcaster or other medium, about the broadcaster and/or program content, or otherwise, for example; and the base unit may include processing capability to decode, store, recall, and/or display some or all of that information, or otherwise to process the information (for example, to sort it or analyze it), such as to facilitate content selection.

According to a second aspect, there is provided by the control unit a radio tuning interface which presents to a user a bandless tuning experience even when the radio receiver in the base unit covers multiple bands of the radio spectrum. Such a radio tuning interface for a radio receiver having apparatus for receiving signals broadcast on a first band and signals broadcast on a second band, may provide the user an integrated presentation of both bands concatenated into a single continuum such at all that is required to select such signals is the rotation of a single frequency selection knob or the actuation of a single up/down switch (or switch pair if up and down are assigned to individual switches). The bands are presented as successive adjacent positions in the continuum. This also enables cross-band “seeking” and “scanning” for a station or content of interest. The interface may include a counter or encoder for tracking position of the knob or switch(es) and a processor for generating signals in response to said position, the signals mapping the position to a band and a frequency within the band, a display connected and arranged to display said band and frequency, and a tuner interface supplying said band and frequency signals to a tuner in the base unit.

Optionally, the tuner may include so-called one or more station “preset” buttons, which may be used to store, and quickly recall with a simple button press, a desired station(s). If desired, the preset functionality may be combined with information captured from a signal source, such as a radio station, such as the station's call letters. A “soft” button may be provided (e.g., on a touch screen or other input device) and the button may be labeled (by the processor) with the station's call letters. Or a button label area may be provided on screen (e.g., for hardware buttons) and the call letters or station frequency may be displayed there, even if the area is not touch-responsive. Optionally, a sorting algorithm may be used to sort such information and to re-assign stations to preset buttons; for example, to sort stations by music type, if that data is made available. Systems such as RDS supply a number of types of information and different users may wish to use that information in different ways. Preferably, therefore, a mechanism (e.g., software running on a processor in either the control unit or the base unit) is provided to place the unit into a user-programmable mode wherein the user may, through menu picks and other input conveniences, select which information to use and how to use it. Innumerable arrangements are possible by virtue of including a programmable processor element and memory in the control unit and/or the base unit.

A network interface may allow connection to local or remote content sources, via a wired or wireless network.

Signals from terrestrial radio broadcasts (e.g., AM, FM and HD radio broadcasts) and any of such additional sources as satellite broadcasts, internet URLs and the like all may be presented in a unified tuning environment as discussed above, with rotations of a tuning knob or actuations of up/down switching causing content selection to transit seamlessly from one band or source to the next, in sequence, without any need for a user to separately select a band or source at the time of content selection.

Yet another aspect of the system is the architecture of providing a base unit and a remote unit which communicate wirelessly, preferably by RF (though an optical—e.g., infrared—link is also an alternative), and each having a processor, whereby great flexibility and capability are provided, as outlined above and below. In particular, such arrangement allows control functions for the media source to be generated in the remote unit with the base unit basically relaying them, or the task may be divided such that the remote unit commands the base unit and the base unit commands the source. Thus, we refer to a “controller unit” generically as including both alternatives.

Still another aspect is a portable digital media player controller unit arranged to store media file metadata used to control a remote media server for accessing content to be served. The arrangement comprises a (preferably wireless) network interface, a handheld display device arranged to display a user interface having a number of user selectable items, and a processor unit that in response to a user selection of one of the user selectable items generates a signal that is sent by the network interface to the remote media server, the signal including media file metadata identifying at least one media file stored on the media server that, in turn, responds to the signals by accessing the identified media file and once accessed, transmits the content of the identified media file to a playback device. The processor unit may be separate from or part of the handheld device.

Another aspect is a method of accessing content stored on a digital content storage device (e.g., the aforementioned server—which may be a portable player or a stationary server) on which one or more content records contain metadata defining content (e.g., entertainment media content such as songs or videos) on the device, comprising downloading from the device to a controller unit at least some of said metadata; storing said downloaded metadata in a database accessible to the controller unit; and accessing content on the storage device from the controller unit using the database of downloaded metadata. The controller may, for example, be or include a portable, hand-held unit; and the database may be in the controller unit (e.g., in the hand-held unit or in a base unit accessible by the hand-held unit, as by a wireless link, or in both of them or partially replicated between them). The database may be maintained in RAM to facilitate speed of access.

Downloading at least some of said metadata may take on different embodiments. According to one type of embodiment, downloading at least some of said metadata may further include: issuing to the device a command to retrieve from the device a list of artists for whom content records are stored on the device, writing the list of artists to the database, for each artist so identified, issuing to the device a command to retrieve a list of all of that artist's albums, writing the list of albums to the database so as to interrelate the artists to their albums, for each album so identified, issuing to the device a command to retrieve a list of all songs thereon, and writing the list of songs to the database so as to interrelate the songs to at least their albums. In this manner, a database is created in which each song is uniquely identified and indexable by a combination of the artist/album/song names. According to another type of embodiment, less information is downloaded and stored. For example, downloading at least some of said metadata may further include: issuing to the device a command to retrieve from the device a list of songs for whom content records are stored on the device and writing the list of songs to the database. A list of the corresponding artists and albums may be compiled at the same time. Then, on demand, when a user selects an album or an artist, a command(s) may be issued to the device to retrieve a list of the songs on that album or the songs performed by the named artist. Since only a small amount of data is needed in response to such a command/query, the operation can be performed quickly, with no noticeable latency.

When a full database is compiled, it may comprise any suitable data structure in memory, such as a tree structure with the list of artists at a root level, the albums for each artist at the next level and the songs for each album at a third level. The data structure or a representation thereof may be displayed to a user on a display screen of the controller, to allow a user to select content to be played. In response to user selection of content, the controller may then construct an addressing path to the content automatically from the user's traversal of the data structure, and retrieve the selected content using the constructed addressing path.

Some aspects of the system have considerable utility to automotive and automotive-like applications. For example, in some embodiments, a unified tuner is applied to an automobile radio. In some of those embodiments, content or channels of content from three or more sources (of which, each of AM and FM broadcast sources comprise two sources, one each for AM and FM broadcasts), all in a unified arrangement not requiring user switching or selection of an input source. And in some of those embodiments, seek and/or scan functions are provided, with signal level or quality level applied to filter out sources that will not deliver a signal of acceptable strength or quality. In some embodiments, means are provided for the automobile driver to have access to only limited controls for content selection, such as a unified tuning control that allows forward/reverse movement among content, while a more robust interface may be provided to passengers in the form of a fixed and/or wireless control unit allowing full functionality as discussed herein—e.g., personalization of favorites lists, jump buttons, etc. These features may be combined with other features discussed herein, such as the docking of a portable music player. In this manner, driver distraction is minimized while providing passengers broad, flexible and simple access to content.

The original claims presented herein may indicate other inventive aspects.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a high-level block diagram of an example of a system as taught herein;

FIG. 2A is a pictorial view of an example of a remote unit for a system as taught herein;

FIG. 2B is a pictorial view of a system as taught herein with the detachable remote unit of FIG. 2A docked with an example of a base unit,

FIG. 3 is another high-level block diagram further illustrating the architecture of the components of the remote unit and base unit in an exemplary embodiment;

FIG. 4 is a diagrammatic illustration of the signal flow between the remote unit and base unit when the remote unit is undocked;

FIG. 5 is a diagrammatic illustration of the signal flow between the remote unit and base unit when the remote unit is docked;

FIG. 6 is a front view of an example of an entertainment unit as taught herein, with a docked remote control unit and a simulated display;

FIG. 7 is another front view of the unit of FIG. 6, showing a top panel open to receive an ASM;

FIG. 8 is still another front view of the unit of FIGS. 6 and 7, with an Auxiliary Source Module (ASM) docked;

FIG. 9 is an isometric top view of the unit of FIGS. 6-8, showing an example of an interface module for an ASM;

FIG. 10 is a diagrammatic, exploded view of a portion of the interface module of FIG. 9;

FIG. 11 is a top view of the example entertainment unit showing an interface module in place with the cover open and no ASM docked;

FIG. 12 is a block diagram of audio routing in the base unit to effect some optional “fail-safe” alarm features;

FIG. 13 is a front view of a base unit of an example system, with an Apple Computer iPod player installed as an ASM and the wireless control unit undocked to reveal a snooze alarm kill switch and (at the bottom) contacts for interfacing directly to the control unit when it is docked;

FIGS. 14 and 15 are close-up views of a display on an example of a control unit, illustrating on-screen labeling of soft buttons (shown below the screen on the control unit); and

FIG. 16 is an isometric view of an example of a system as discussed herein, with a docked control unit (or permanently attached control unit) and another ASM, perhaps a satellite receiver, docked on top.

### DETAILED DESCRIPTION

This invention is not limited in its application to the details of construction and the arrangement of components set forth in the following description of example embodiments, or illustrated in the drawings. The invention is capable of being implemented in other embodiments and of being practiced or of being carried out in various ways, as will be apparent to those skilled in the art from these illustrative examples. Also, the phraseology and terminology used herein is for the purpose of description and should not be regarded as limiting. As used herein, a “processor” can be implemented in any convenient way. It may, for example, be a programmable microprocessor or microcontroller, or it may be an application-specific integrated circuit (ASIC) or it may be hard-wired circuitry, or a neural network, or a gate array or FPGA (field-programmable gate array), or any other form of information processing device. A microprocessor is discussed as a practical example, not to be limiting. The use of “including,” “comprising,” or “having,” “containing,” “involving,” and variations thereof herein, is meant to encompass the items listed thereafter and equivalents thereof, as well as additional items.

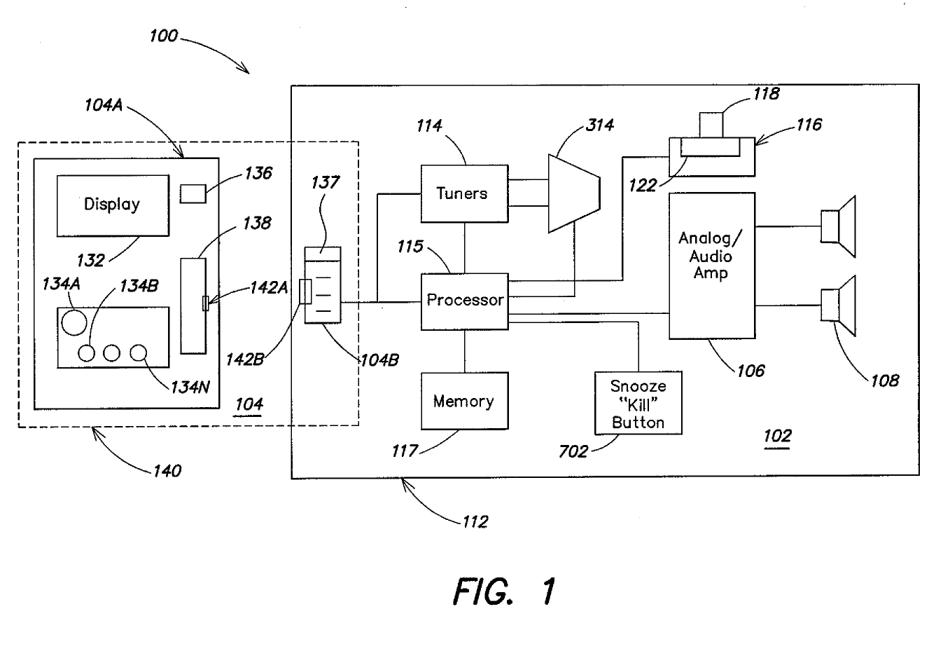

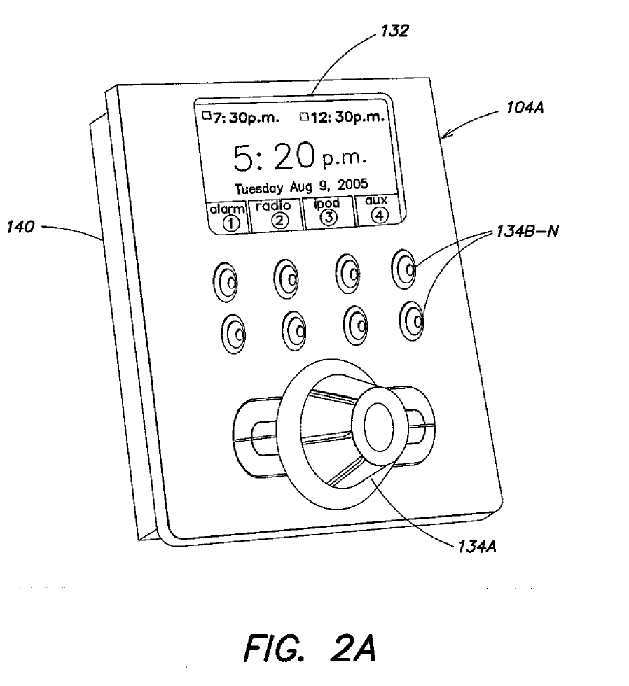

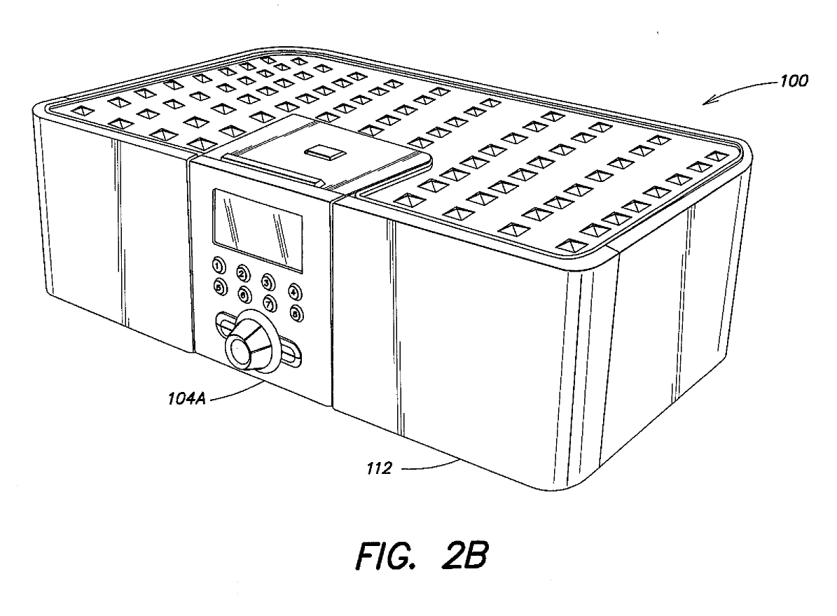

As shown in FIGS. 1 and 2 (i.e., FIGS. 2A and 2B), an entertainment system 100 of the type to be discussed herein has a number of sub-assemblies. These include at least a base or table unit 102 and a control sub-assembly 104. The base unit 102 further includes an audio amplifier 106, one or more (preferably at least two) loudspeakers (or speakers) 108, and housing 112. (As illustrated, the speakers 108 are within housing 112, but this is not required.) It may also include a tuner 114 and/or audio signal source interface sub-assembly 116 connectable to one or more detachable devices 118 (also called Auxiliary Source Modules, or ASMs). The control sub-assembly may include a two-mode, detachable control unit 104A and an interface therefor, 104B, in the base unit. The detachable device 118 is preferably a digitally controlled device that supplies an audio signal (in any acceptable format, analog or digital), via the interface sub-assembly 116, to the audio amplifier 106. For example, the audio signal source in an ASM may be a portable music player (e.g., a device such as an iPod digital player from Apple Computer, Inc. of Cupertino, California or another music player that provides signals in a known format such as the well-known MP3 or AAC protocols), a wireless network adapter, a satellite radio receiver, a CD or DVD player or any other device that can be plugged into interface sub-assembly 116 at connector assembly 122. When the ASM is plugged into the interface sub-assembly, it supplies audio signals to the audio amplifier sub-assembly under control of the control sub-assembly. When the audio signal source (i.e., ASM) supplies an audio signal in a digital format, the audio signal is first routed through a decoder (e.g., in a codec) before the analog decoder output is routed to the audio amplifier. The decoder may be a dedicated module (not shown) or it may be implemented by software executing on a processor 115 which has multiple functions. The decoder must be appropriate to the signal format, of course, and various appropriate decoders will be familiar to software developers and other appropriate engineers.

ASMs can be configured in various ways, to permit stacking, for example, or daisy-chaining via cables and connectors, or combinations of the two. Such electrical arrangements of peripheral devices are now common, using protocols such as the popular USB protocols, for example. Of course, any suitable protocols may be used to arrange to connect a base unit to multiple peripheral ASMs via a single interface sub-assembly 116.

When a network adapter is used (wired or wireless), the system may control a remote device (personal computer, etc.) which can then act as a server of music and other files to the base unit (e.g., from Apple Computer's itunes service or the like) or as a streaming audio source. With appropriate decoder software executing on processor 115 or another processor (not shown), the device can play songs provided in various music formats, such as WAV, MP3, WMA, and AAC, among others. The system may provide for receiving, storing and playing back broadcast content. The remote device may serve up music content from various sources, such as a hard (magnetic) disk drive, an optical medium (e.g., CD or DVD), or electronic memory (e.g., RAM), any of which may be internal or external to the processor which acts as a server. For example, the remote device may serve up content from an attached portable music player such as an iPod device. As further explicated below, the remote device and/or its music source may be controlled via a local control unit such as detachable control unit 104A. Thus, for example, a user may be in one room of a house with control unit 104A and control the delivery of music from a source in that room, in another room (directly via wireless operation or via a network), or even from a source external to the house. To facilitate operation of the control unit and the selection of music to be played, the control unit may operate upon metadata which serves to identify music selections and where they are sourced from, as explained elsewhere herein. Such an arrangement may, if desired, result in a docked portable music player or other source not only playing content via the amplifier in the base unit, but also, or alternatively, via an appropriate codec and networking module, and optionally using streaming software, serving content to other networked destinations. The control unit may select the content from the source, control local volume, etc., at the same time.

The detachable control unit 104A preferably comprises a display device 132, one or more input devices 134A-134N, a wireless transceiver 136 and a docking (wired) interface port 138, and batteries for power (not shown), in a housing or stand 140 designed to mate with the base unit 102. Preferably, when mated, the control unit 104A and base unit 102 appear to be an integrated device. Optionally, when detached from the base unit, the control unit may be supported on a cradle of convenient design, such as an angled piece of plastic or other material, the arrangement and style of the cradle being a matter of design choice. The cradle may include a power source to charge a battery in the control unit, when the control unit is placed on the cradle.

The control unit 104A may operate in two modes. In a first, docked mode, the control unit is electrically connected to the audio amplifier and signal source electronics sub-assembly via a set of connectors or terminals 142A, 142B and its wireless transceiver is disabled. This “wired” connection conserves battery power (power for the control unit being supplied by the base unit), and in a typical implementation it also allows the battery power supply to be recharged from the base unit, simplifies the wireless connection as it is engaged only when the wireless mode is used, and provides the reliability of a direct electrical connection, with reduced susceptibility to electromagnetic interference. In a second, undocked mode, the control unit is separated from the base unit and the electrical connection at connectors 142A, 142B is broken. The control unit switches (preferably automatically, with appropriate circuitry detecting the undocking) to battery power and intercommunicating wireless transceivers in the control unit and base unit are enabled.

Preferably, the wireless transceivers provide and receive signals compliant (at least at a physical level) with an industry standard, such as the ZigBee standard. This allows use of inexpensive, mass-produced transceivers. (Of course, custom wireless transceivers may be used, or transceivers compliant with other standards.) As for the logical levels of the signaling protocol, standardized or proprietary specifications can be employed. One advantage of using a proprietary signaling protocol is that other devices would not be able to control the base unit (e.g., remote controls for other systems, or stray signals of other systems). Optionally, a signaling protocol may be used which allows multiple control units to interact with, and control, the base unit. That way, the user may deploy control units in different rooms in a house or in different places in the same room, for example.

The control unit preferably includes a display, such as a liquid crystal (LCD) screen, for showing the user textual and/or graphical information such as is typically displayed on a home entertainment device. For example, such information may include a selected input device (e.g., built-in radio tuner, iPod portable music device, network card, etc.), volume, song and/or station being listened to (if operating in a radio mode), source URL or IP address in the case of internet sources, control functions, etc. Preferably, the display is capable of presenting standard bitmapped graphics to the user, but displays using other formats are certainly acceptable; bitmapped graphics simply provide the maximum display flexibility at the lowest cost. The combination of a processor-operated bitmapped display screen, together with a knob and buttons that can be pressed to move a cursor and indicate a selection (using conventional hardware and software to enable these functions), provides for a menu-driven user interface established by software executing on the processor. The details of the interface selections are a matter of design choice. The input source and other user information preferably is displayed on the display screen. Desirably, when the user has selected the tuner as the audio signal source, the system receives and displays RDS (Radio Data Service) broadcast information in a conventional way, which allows a user to receive information relating to the song being played, such as the song title and recording artist. Using conventional techniques, the display screen can be programmed to deliver content in multiple selectable languages. In other embodiments, display content may be replaced by or complemented by voice prompts during user-defined operations. The use of voice prompts permits operation by vision-impaired individuals.

The display outputs data obtained locally in the control unit and/or obtained from the base unit via the interface. In addition, the control unit includes input devices such as one or more switches and one or more knobs. One of the knobs, 134A, preferably is a tuning knob, as a rotatable knob appears to be widely adopted and preferred for radio station selection and other inputs of home entertainment devices. A knob, however, certainly is not a requirement. Any suitable input device may be substituted, such as a switch or switches for directing upward and downward frequency change or forward/reverse movement along a progression of available content. The content may include content from any one or more available sources presented in a unified interface, including without limitation radio broadcast sources, internet sources, local area network servers, ASMs, etc.

### Tuning

Preferably, the tuner (the design details of which are not relevant, as any conventional electronic tuner can be adapted for use in this system) is capable of receiving broadcast signals from different radio bands, such as the AM band, the FM band, HD broadcasts, other radio sources such as satellite broadcast bands (which may be subscription services), or direct audio broadcast or internet broadcast or other such services. Each of those bands occupies a different segment of the radio frequency spectrum or the equivalent, addressable “space.” Each radio band typically is allocated to a broadcast service which, by regulation, employs a specific type of modulation and/or coding scheme for encoding information that is transmitted; for example, in the AM band, amplitude modulation is used; while in the FM band, frequency modulation is used. (Likewise, the other services use distinct modulation or encoding schemes.) In a typical AM/FM radio, the processing of a received AM signal is thus usually performed by circuitry which is almost completely different from that used for processing a received FM signal. The outputs of the AM processing section and the FM processing section are, however, supplied to an audio amplifier and speakers shared by those two sections. Typically, a user operates a band selection switch to choose which of the two sections is connected to the audio amplifier, and sometimes to choose which section receives power. Appropriate mechanics, logic and circuitry may switch the source of some of the screen information to show appropriate frequency and other information according to the selected band, and to connect the input controls to control the frequency setting of the selected section and sometimes to adjust functions such as sensitivity or filtering.

At one time, the program content of AM and FM stations were markedly different. FM broadcasts are better suited to the delivery of music and tended more to provide music content. AM broadcasts were largely used for talk shows, news reports, sports and the like, with less music. Programming in the two bands is now far less distinct than it was decades ago and users often make less distinction between the two bands than was true years ago. Talk shows, sporting events, etc. are frequently broadcast on the FM band, for example. Yet users still have to consciously switch between bands on their AM/FM and other multi-band radios.

Likewise, when a home entertainment system or automobile entertainment system provides access to sources other than radio broadcasts, the user typically has to actuate switches manually to select the source desired at any given time. This is problematic for automobile drivers who must shift their attention from driving to finding the controls to select the desired source.

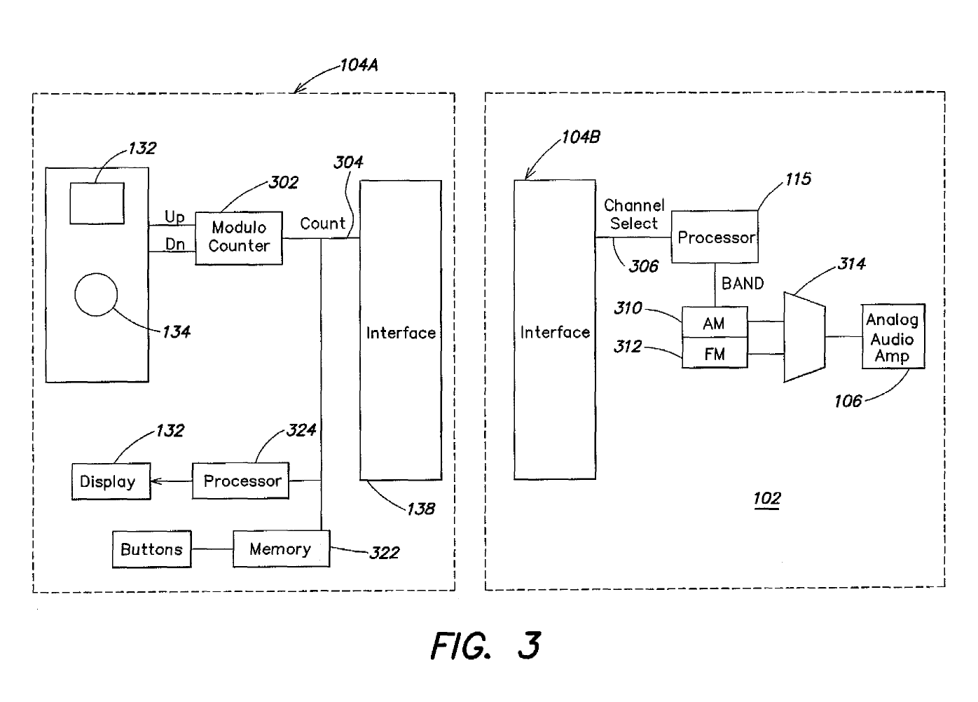

Turning to FIG. 3, there is shown in block diagram for an arrangement we call “unified” tuning, whereby no AM/FM switch is presented to the user and the user does not have to activate a switch to change bands. Instead, one simply tunes from the end of one band directly into the beginning of another band, as though they were contiguous in frequency. The illusion is given the user of single band operation. The concatenated bands can be arranged in a loop, so that the top end of the last band in sequence wraps to the bottom end of the first band. If there are three or more bands, they may be arranged in any desired sequence.

To effect this operation, various implementations are possible. The implementation shown in FIG. 3 is presented by way of illustration and example only, not to illustrate specific circuitry. There, an all-digital control system is depicted for selecting the active tuning section and connecting it appropriately. A tuning knob 134A provides UP and DOWN (DN) counter control signals (in response to clockwise and counterclockwise rotation, respectively) to associated circular (modulo) counter electronics 302, the design of which is well known to electronics engineers. The counter 302 supplies a digital output signal on line 304. The digital signal on line 304 represents a count value from a counter whose count increments, for example, as the tuning knob is rotated clockwise, and whose count decrements as the tuning knob is rotated counterclockwise. The COUNT signal on line 304 may represent a number from zero through a maximum value determined by the designer to resolve at least a certain predetermined number of radio station channel assignments so that there is a 1:1 mapping of count values and channels (frequencies). Through whichever interface is employed at the time (wired or wireless), a corresponding CHANNEL SELECT signal is conveyed on data line(s) 306 to a processor 115. The processor maps the CHANNEL SELECT signal to the band to which the count corresponds and (a) sends to the tuner a BAND signal or equivalent which switches on the corresponding one of the receiver units 310 (for AM) or 312 (for FM), (b) supplies a FREQUENCY signal to that receiver unit, and (c) selects the output of the selected receiver unit to be connected to the input of the audio amplifier by supplying an appropriate control signal to a multiplexer 314, for example. The output of the multiplexer 314 is connected to the input of audio amplifier 106.

Assume that there are not just two, but three, bands covered by the receiver, for example: the broadcast AM band of approximately 535-1650 kHz, the FM band of approximately 88-108 MHz, and a third band covering weather service channels in the 162.4-162.55 MHz range. Like the FM broadcast band, the weather service broadcasts are transmitted using frequency modulation. There are thus six band limits: the lower and upper limits of each band. Let us call the lower limit of the AM band AML (denoting the value of the CHANNEL SELECT signal corresponding to that lower limit; the upper limit of the AM band, AMU; the lower limit of the FM band, FML; the upper limit of the FM band, FMU; the lower limit of the weather band, WL; and the upper limit of the weather band, WU. Thus if AML≦CHANNEL SELECT≦AMU, then the processor provides a BAND signal that selects the AM receiver and activate AM reception. Similarly, if FML≦CHANNEL SELECT≦FMU, the processor provides a BAND signal that selects the FM receiver and activate FM reception. If WL≦CHANNEL SELECT≦WU, the BAND signal also selects the FM receiver, to effect reception of an FM signal, but the value of the FREQUENCY signal will be appropriate to the weather band instead of the FM band. Clearly, this methodology may be extended to the use of different or additional bands or services that are accessed using a tuning metaphor or mechanism, such as DAB, satellite and HD radio.

Various receiver circuits may require tuning component or parameter changes or customizations for different broadcast bands, such as different antennae, different bandpass filters, etc. All of these customizations can be controlled appropriately from the BAND signal(s) or from a combination of those signals and the FREQUENCY signal, as will readily occur to those skilled in the art.

In some embodiments, the tuner may be placed into a “scan” mode whereby, taking advantage of the “unified” tuning capability, the tuner may cycle through a series of frequencies associated with a first band and then begin automatically to scan through a series of frequencies of a different band. For example, a user may initiate the scan feature when the tuner is initially set to a station “low” in the AM band. The tuner cycles through the AM band, playing short (e.g., three-second) samples of each station it encounters. At the top of the AM band, whereas most radios would begin a second survey of the AM band starting back at the bottom, instead the system begins a scan of the FM band. Scanning may combine other bands or different bands, or be limited to a single band, at the user's selection. This operation is particularly useful in automotive environments, to minimize a driver's distraction incurred when interacting with radio controls.

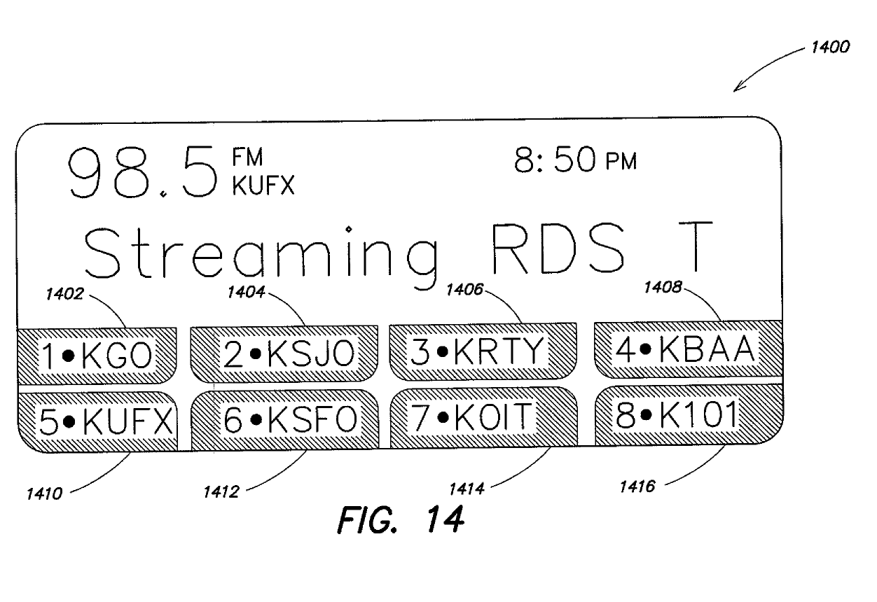

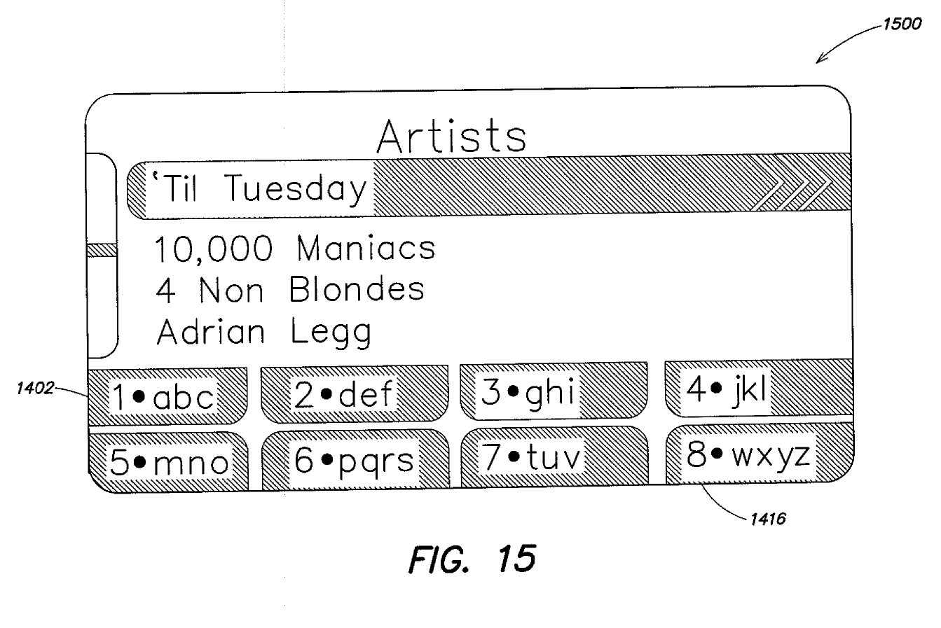

In other embodiments, unified tuning may be adapted to not only broadcast signals, but also to include signals from arbitrary sources—e.g., sources of the various types mentioned above, with a coordinate for selecting a specific signal being something other than a broadcast frequency, such as an internet address or song identifier or the like. Each source may be assigned a range or number of access coordinates that are addressed much the same way as broadcast signals are addressed: with the output of a counter mapping to a specific content selection. In this manner, it is possible both to obtain random access to any available source content, treating all content fungibly from the user's perspective, and to scan broadcast signals as well as signals input from various peripheral devices (e.g., ASMs), allowing (for example) the system to scan or seek through content in the FM and satellite bands, and from entries in a local music library. All of these variations require no more than minor programming changes that will be obvious to anyone skilled in programming within the architecture of the system. For example, the unified tuning feature may be coupled through software to the RDS information, also, so that scanning is limited to stations that meet certain user-defined criteria. For example, with the unified feature turned on and a metadata filter applied to source content labels, scanning can be set to sample only stations broadcasting in talk radio format on the AM, FM and satellite bands. On a tabletop system or car radio, dedicated or soft (programmable) buttons (which may be self-labeling on the display) may be provided, to be preset to filter stations according to characteristics programmed into the button. A user might set up, for example, a country music button to either list country music stations and allow a user to pick one, or to scan all of the country music stations; a sports button, an “all news” button, or a button dedicated to call a specific song or playlist from an auxiliary source such as an iPod player, also may be set up, with an appropriate codec assigned. Alternatively, some or all of the preset buttons can be mapped to corresponding positions of the tuning knob (encoder) and treated the same as radio stations, for simplified, pre-configured access, scanning, etc. With reference to FIGS. 14 and 15, there are shown, respectively, examples of display screens whereon radio stations “presets” have been mapped to eight soft button labels indicating how the soft buttons will operate when pressed (FIG. 14) and whereon an alphabetical keypad arrangement is mapped as an alternative for use in navigating a song index, for example (FIG. 15).

The arrangement shown in FIG. 3 and discussed above is exemplary only. Numerous other configurations will readily occur to those skilled in the art. For example, in the example, the counts (channel selection signals) for AM, FM and weather bands are expressly neither contiguous and continuous nor discontinuous; they may be either. Also, those bands may be divided into sub-bands, if desired.

When one of the “bands” is a digital “radio” service, such as a satellite, internet or direct audio broadcast service, then one merely employs a processor running browser or other software as the “tuner” for accessing that service, or a similar “receiver,” and tuning involves the BAND signal being a signal to start the receiver (e.g., start the browser or other software and connect to the Internet) and the FREQUENCY signal supplying a URL or Internet IP address instead of a frequency. Memory can supply to the display any desired identifier for the “station.” Each of these non-radio-frequency broadcasts can be mapped to its own band for tuning purposes.

The button- or knob-generated count may be used directly or it may be mapped to whatever type of signal or value the signal source expects for addressing a specific channel or content.

With this “unified” tuning methodology, the user need not even be concerned with whether a particular station is in one band or another, or which network address, satellite channel or CD track or other source will provide the particular song or artist desired.

Further, it has been common practice to provide on some tuners a number of buttons for station “presets;” that is, buttons which can be assigned to preselected stations so that the user has fast access to those stations by merely pressing the assigned button. However, the number of buttons provided is finite, typically in the neighborhood of about six or eight, most often (but not always) with a dedicated number of button positions for each band. Yet one user may wish to listen (in the extreme) only to AM stations and another user may wish to listen (again, in the extreme) only to FM stations.

Thus, each user would be able to use only the six or eight (or other number of) buttons provided for his favorite band and the other buttons would be unused. By contrast, as stations herein are mapped to CHANNEL SELECT counts and those counts are “agnostic” as to band/signal source until the processor decodes them and directs them appropriately, a preset button in this system preferably stores a station or source location count in a memory 322 in a “record” mode and then causes that count to appear as the COUNT and CHANNEL SELECT signals when the preset button is pressed, overriding the knob (counter) output. In this way, the buttons can be assigned to content or content sources (e.g., radio stations) in any band. If twelve buttons are provided, the user can assign them all to a single band or assign them in any arrangement and number to different bands. The user might, for example, group the button assignments according to the program content type of specific stations, regardless of band/source. For example, the first two buttons might be assigned to AM and FM stations that have good weather reports. The next three buttons might be assigned to one AM station and two FM stations that play “oldies” music. And so forth. Note that it is unnecessary for the user to use a switch to select a band; thus, there is no AM/FM switch.

In the control unit 104, there preferably is provided a processor 324 which performs various functions, including controlling the information shown on display unit 132. This processor receives the count output by the tuning knob circuitry or “preset” buttons, if any are provided, and converts the count to a source addressing (e.g., frequency) assignment (e.g., through use of a lookup table or algorithm, not shown) which is then shown on the display unit. Optionally, other information may also be displayed on the display unit, such as the time and/or data supplied in a signal from a radio station, including the station call letters, type of program content, name of a song being played and the artist and album, or other information.

Preferably, the processor in the control unit and the processor in the base unit are the same type or family of processor, whereby much of the software need be written only once and can be used by both processors.

The control unit may also include circuitry and programming for the processor to provide “alarm clock” functionality, including a clock and interfacing between the clock and the controls of the radio circuits. Such circuitry is conventional and need not be shown in any detail.

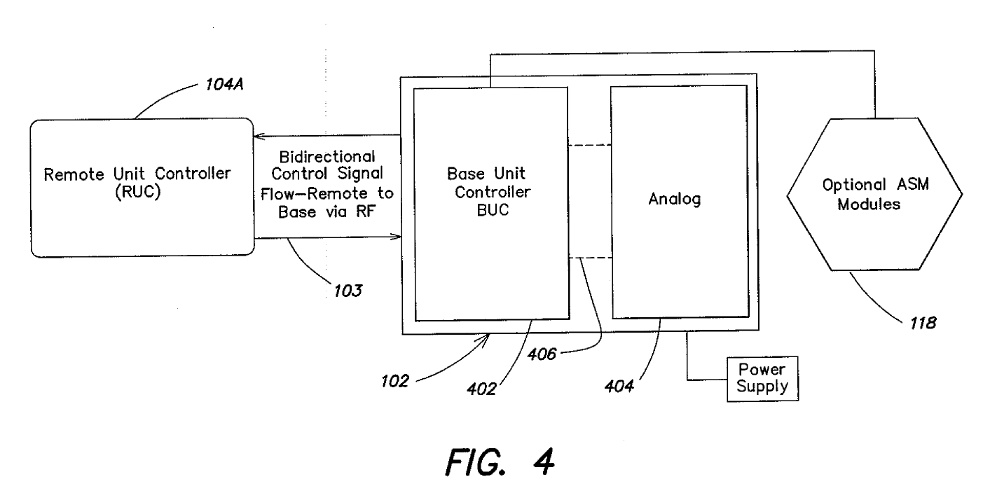

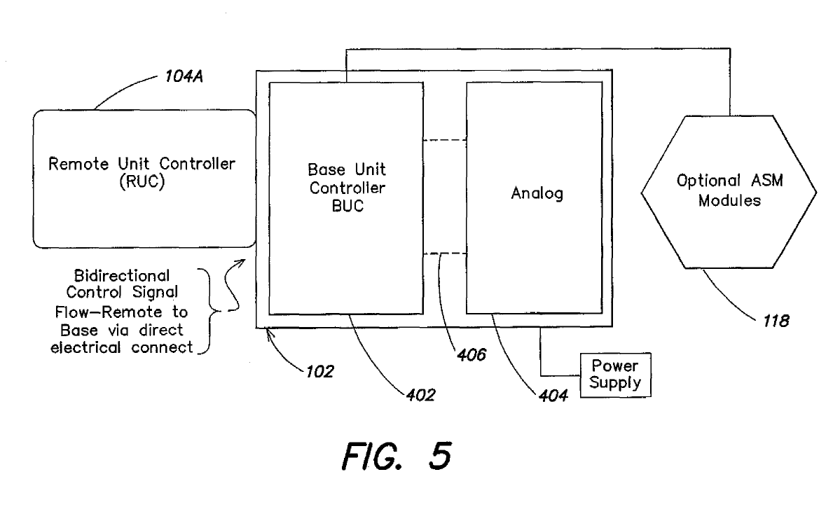

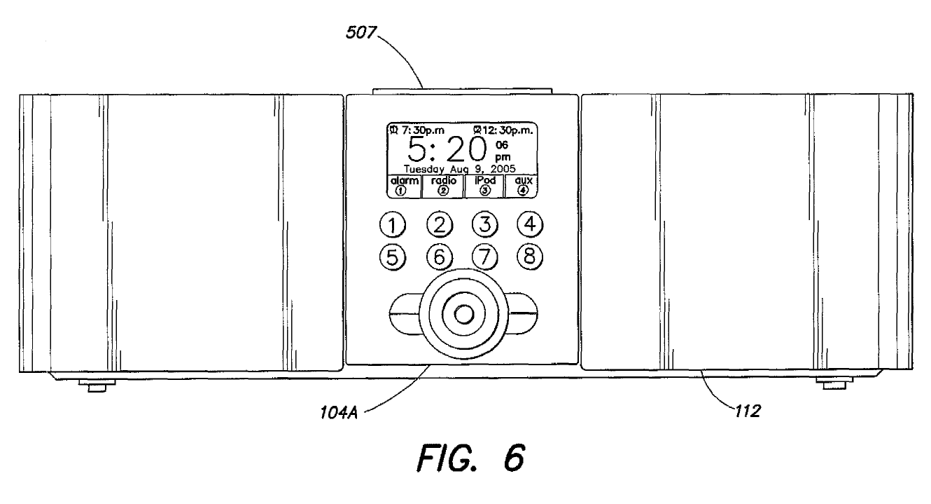

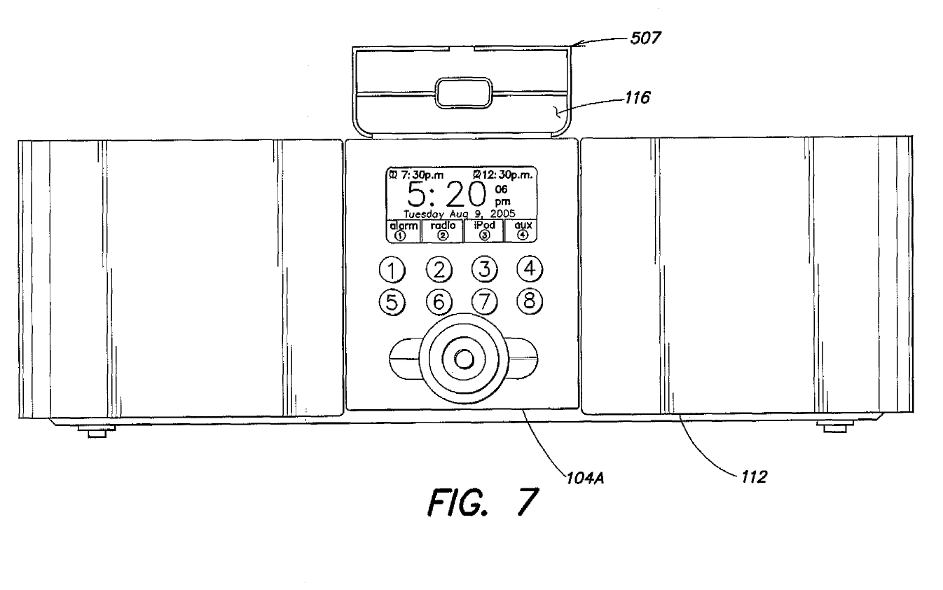

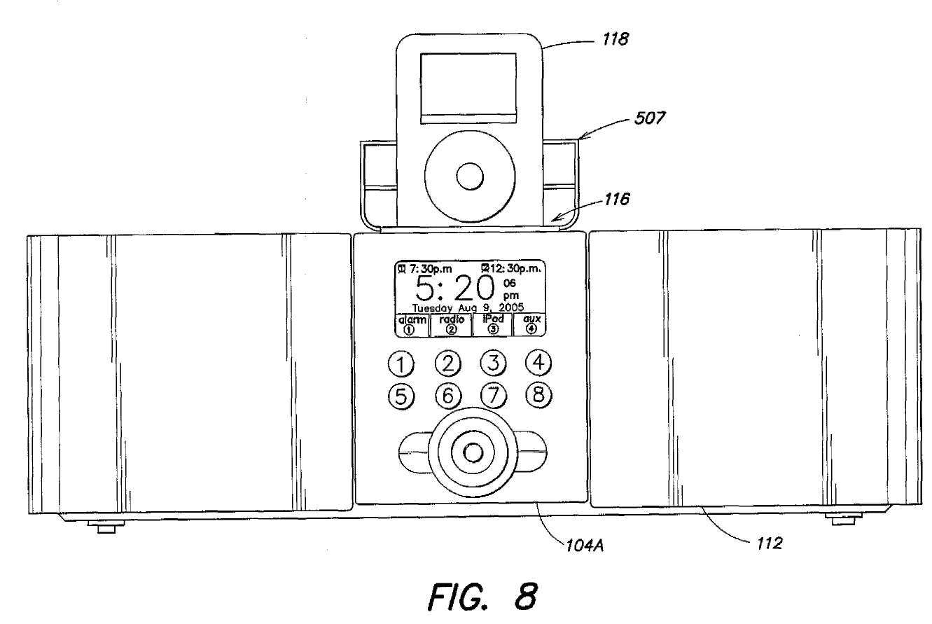

Referring now to FIGS. 4 and 5, there are illustrated examples of the signaling operation which may be established between the control unit and the base unit in, respectively, the undocked and docked configurations.

In the undocked configuration, the control unit 104A (labeled “Remote Unit Controller”) communicates with the base unit 102 via a wireless channel provided by, for example, a ZigBee-compliant (or partially compliant) transceiver.

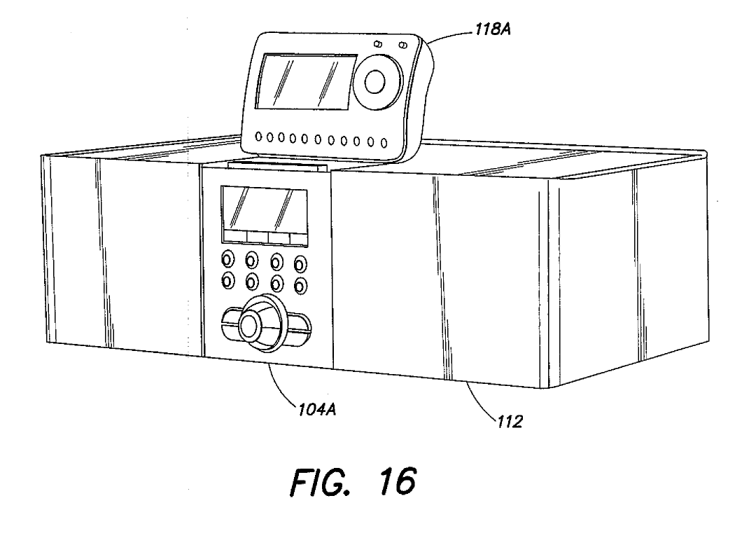

In the base unit the described functionality may be implemented in many ways, the selection of which is based on practical considerations of cost, space, power consumption, and the like. One typical arrangement is shown in FIGS. 4 and 5. There, the base unit comprises a base unit controller (BUC) module 402 and an analog circuit board module 404. Optionally, the base unit may also have, or be able to receive (e.g., at a socket), a device we term generically an Auxiliary Source Module 118. The Auxiliary Source Module may be any of a number of kinds of devices. For example, it may be a device that provides audio files in MP3 or .wav or other convenient format (e.g., an iPod device from Apple Computer, or other portable music player or CD-ROM drive); a wireless local area network (LAN) card providing connectivity to audio files on a local network server or to a remote server or other source via an internet router, permitting the downloading of music and other files; or a receiver for a terrestrial radio service such as HD radio or a service such as satellite radio, as depicted, for example, in FIG. 16. The output from the Auxiliary Source Module is routed to the BUC module instead of to the analog circuit board, preferably, in order to employ the processor in the BUC module to decode any digital audio signals and convert them to analog form before being provided to the analog module. If the signal is already in analog form, of course, if can be passively routed to the analog module by the BUC module.

The BUC module includes a wireless transceiver for communicating with the control unit, a processor 115, and an interface 406 to the analog circuit board module for control and to pass through analog audio signals. The analog circuit board typically includes audio amplifiers, power regulation circuits, and pre-processing apparatus. The audio output from the analog circuit board is connected or connectable to speakers 108 located inside or outside the housing for the base unit. The AM and FM tuner circuits are preferably provided on the analog circuit board, but they could be provided on a separate board. Likewise, instead of providing a particular source tuner on an ASM, it may be incorporated into the base unit. For example, an HD radio receiver could be built into the base unit, whether on the analog circuit board or otherwise. Networking capability, such as an Ethernet port, also can be incorporated into the base unit rather than being provided via an ASM.

The audio output from the Auxiliary Source Module, if one is provided, may be routed directed to the analog circuit board or via the BUC to the analog circuit board.

In the docked configuration, shown in FIG. 5, preferably the ZigBee transceivers are deactivated when the direct, physical mating is detected, and a wired connection is established between the control unit and the base unit, as well as a power connection to charge the battery(ies) in the control unit. Otherwise, the system functions the same as in the undocked arrangement.

### Universal Docking System

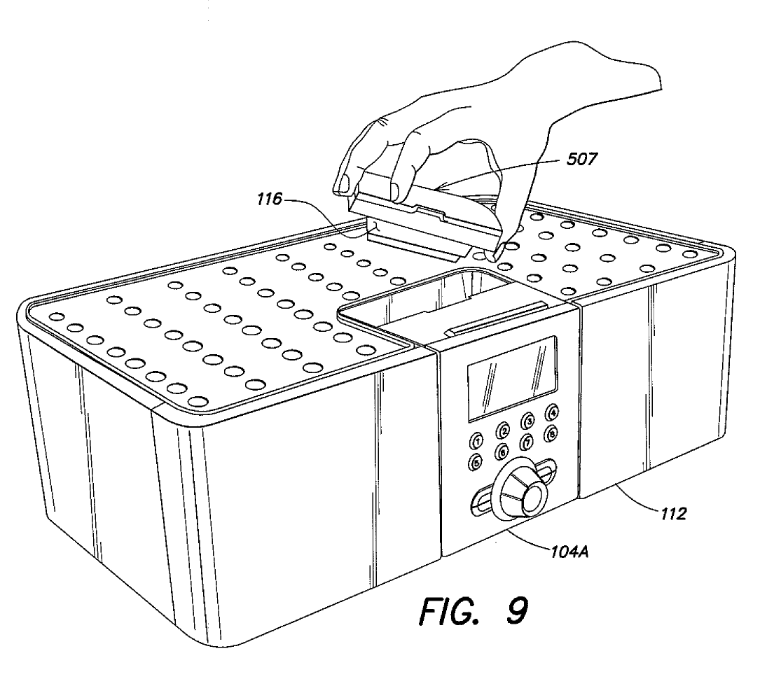

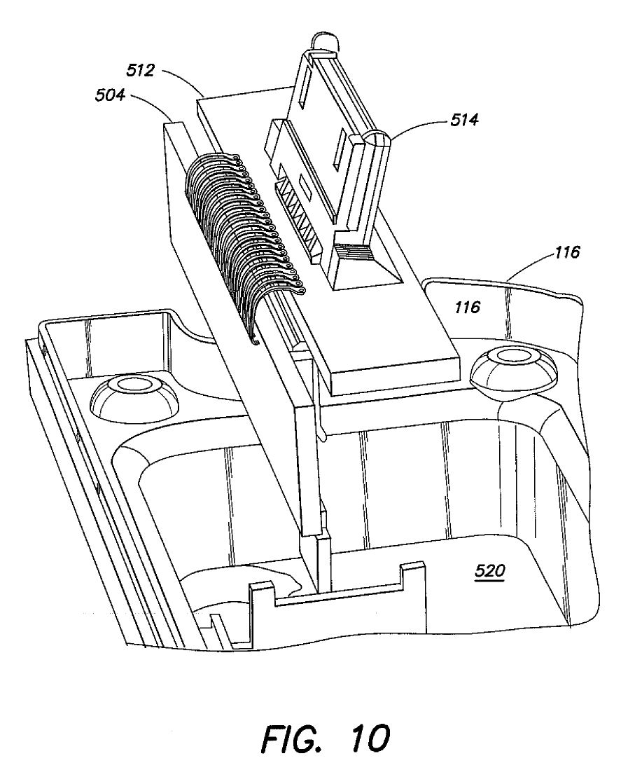

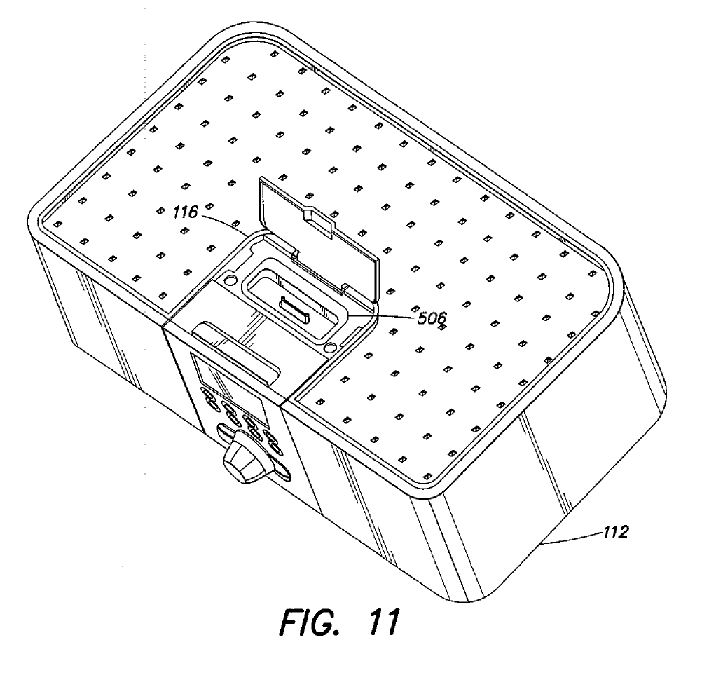

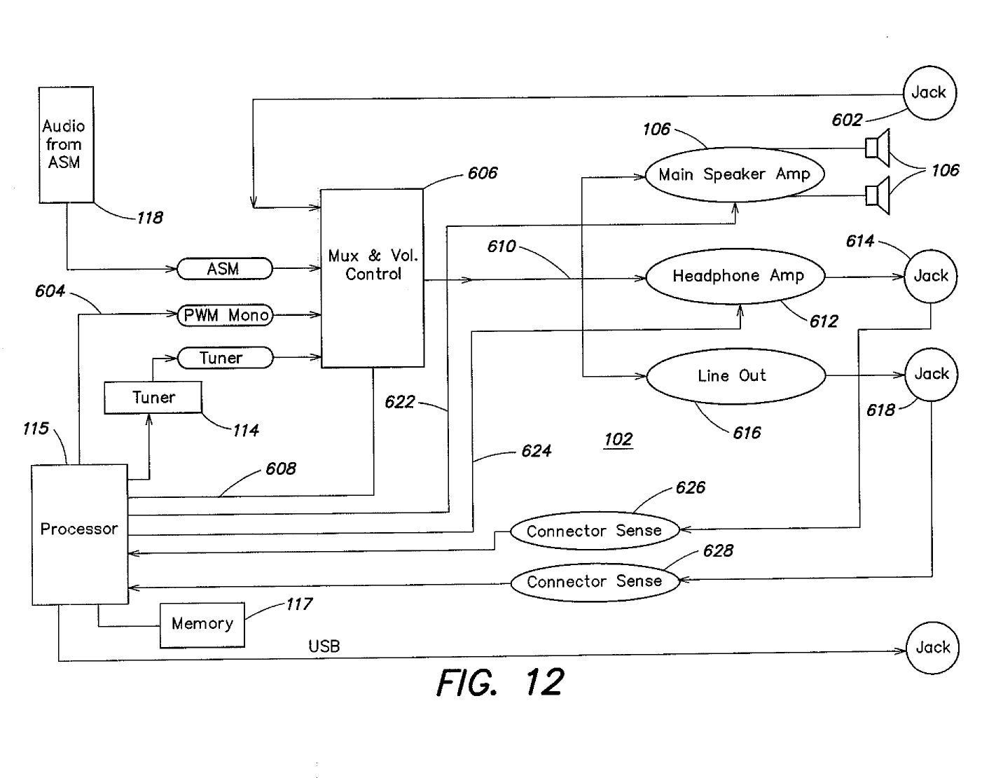

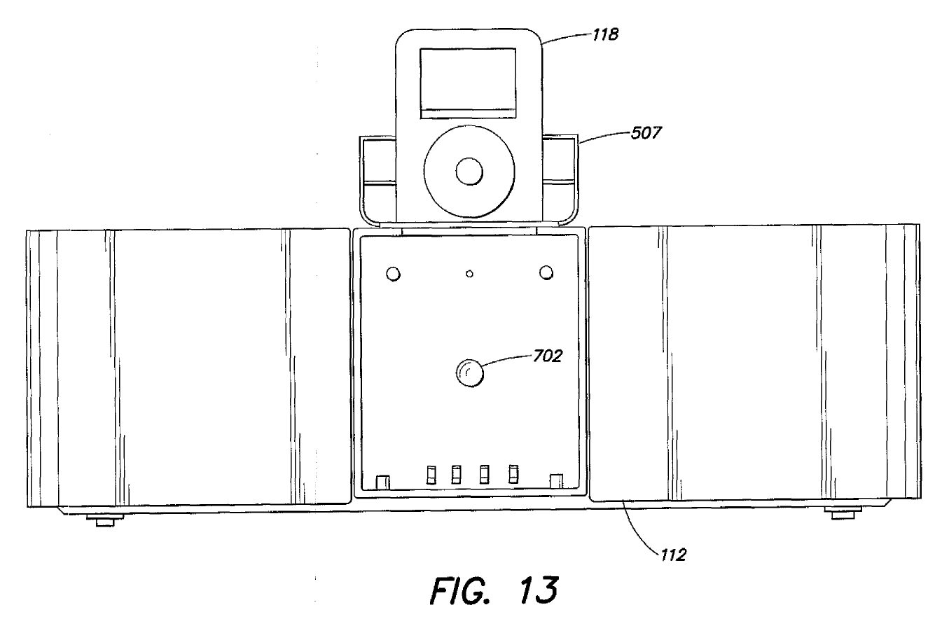

It is desirable, though not required, that the Auxiliary Source Module be connectable to the base unit through a connector. However, it is also true those different signal sources typically will have different form factors and use different connectors. For example, even some of the different models of Apple iPod music players provide different connectors and/or form factors; and Apple iPod devices use different connectors than do Creative Technology's Zen players and XM or Sirius satellite radio receivers. While a system can be made to accept only Auxiliary Source Modules (ASMs) with a certain type of connector and a certain form factor, if the user changes ASM or has multiple ASMs with different connectors and/or form factors, the user would find that the base unit cannot accept all of them or future products of different design. Accordingly, it would be commercially more effective and desirable to permit a user to employ ASMs with a variety of connectors and form factors, interchangeably. For this purpose, a base unit may desirably employ an interface module 116 such as is shown in FIGS. 9-11. The interface module mates to a “universal” connector (not shown) provided as part of the entertainment unit, typically on a circuit board or cable. (The connector is “universal” in the sense that, if it is provided with a sufficient number of connection terminals, or pins, then with the appropriate interface module, a wide range of ASMs can be connected to the base unit.) A typical interface module contains two adapters, a first (electrical) adapter 504 and a second (mechanical) adapter 506. The mechanical adapter may not be required, if the electrical adapter is not “sunken” below the housing surface, as it serves to provide adjustment to the “form factor” of an ASM and to protect a docked ASM and the connectors (on the ASM and in the interface module) from mechanical damage.

The universal connector contains connection pins for power and for the kinds of signals that might potentially (foreseeably) be provided to or received from an ASM. Some ASMs will require fewer connections than others. The electrical adapter 504, in its most basic form, assuming a passive electrical interface suffices, has three components: a first connector (not shown) which is mateable with the “universal” connector (within the entertainment system base unit); an interconnection sub-assembly (e.g., printed circuit board or cable or a combination) 512; and a second connector 514 for receiving an ASM of a particular type. That is, second connector 514 is specific to and compatible with the ASM. In one embodiment, the two connectors may be mounted on different sides of a printed circuit board and the appropriate pins of the first connector may be wired to corresponding pins of the second connector through the printed circuit board, the correspondence being dictated by the functions assigned to the various pins by the ASM manufacturer and the base unit manufacturer. In some situations, not all pins have counterparts. If needed or desired, buffer circuitry can be provided on the printed circuit board, powered from the first connector, to buffer, isolate, amplify or level-shift signals passed between the base unit and the ASM. In another embodiment, which is useful for the configuration illustrated in the drawings, it has been found useful for the interconnection sub-assembly to be formed of a first printed circuit board wired to the first connector, a second printed circuit board on which the second connector is mounted, and a flexible cable interconnecting the circuit boards. Another approach would be to mount the second connector on something other than a printed circuit board, such as a plastic part of the adapter housing, and to interconnect the first and second connectors with a cable, the cable directly connected to the first connector. Still another alternative is to provide two (or more) ASM adapters and switching circuits for selecting one to be active while the other(s) is (are) inactive; or, alternatively switching or arranging one to be an audio source while the other ASM provides other functionality such as networking.

Other configurations may be devised according to design considerations.

Optionally, selected pins of the universal connector can be used to code the identity of the interface module and/or ASM which will be docked. On circuit board 512, the leads from those pins can be tied to “high” or “low” logic levels, so as to identify to the processor in the entertainment unit, via the universal connector in the base unit, a type of ASM. The processor can then retrieve from memory specifications for the ASM and route appropriate signals to and from the pins of the universal connector. Thus, at least some pins of the universal connector preferably are connected to multiplexing circuitry to permit re-routing connections. As new ASM devices are marketed, new specifications can be downloaded to the entertainment unit via a USB port or other interface (not shown).

The mechanical adapter, if used, is intended to provide an appropriate fit between the base unit housing and the ASM, with differently sized mechanical adapters being made available for ASMs of different dimensions or shapes. The base unit is made with an aperture 520 of size sufficient to receive ASMs of maximum expected size. The mechanical adapter 506 has a central aperture sized and shaped and positioned to receive the ASM and to place a connector on the bottom of the ASM into alignment with the second connector of the electrical adapter. The mechanical adapter may, and preferably does, retain the ASM in a slightly recessed disposition, to provide some physical security for the ASM. The mechanical adapter 506 may be provided with a hinged or sliding lid, optionally, to close the aperture 520 and protect connector 514 when no ASM is installed.

### Database Management and User Interface

Apple's iPod and similar players now are sold with sufficient memory capacity to store thousands of songs. While this is a boon to music lovers, it also presents a challenge: finding and playing a desired song among the many that have been stored. Creative Technology of Singapore has recognized this problem in its U.S. Pat. No. 6,928,433, which provides a hierarchical interface to facilitate song retrieval. Additionally, facilities are known for creating stored lists of songs, called “playlists.” A command to play a playlist causes the corresponding list of songs to be played seriatim. Use of playlists is particularly helpful when an MP3 player is used in an automobile, to relieve the driver of the distraction of having to deal with the user interface to choose a song every few minutes.

On the player, songs typically are stored sequentially as they have been recorded. Means are provided on the player to allow a user to scroll linearly forward and backward through the list of songs, and sometimes facilities are provided to select and play recorded playlists.

Beyond the availability of these features, little facility is available for making it easy for a user to identify and play songs. Currently, iPod devices do not provide the services of a database engine to external devices because very little database functionality has been built in. Songs, artists and albums and the like are represented by data records. An external device can select which records are to be made currently active, such as all songs, all songs by artist X or all songs from album Y. When an external device accesses a record, however, the record is identified by its position in the list of currently selected records, not by an absolute identifier. Thus, a single song will have a different identifier based upon how and when the user navigated to a current list (e.g., by album, artist, genre, etc.). One cannot simply express a desire to listen to song 113 and know that The Beatles “Let it Be” will be played. In this sense, there is no unique identifier for that or any other song on an iPod brand music player, usable in a “play” command. Indeed, on any given player of this type there is no static identifier for a particular song. A song is only locatable via an access path, which may change from time to time, and multiple paths may lead to the same song. This situation greatly complicates remote control of such a device. In some players, even when a song is assigned a unique identifier, that unique identifier cannot be used to play a song. Indeed, in some iPod devices, it appears there are two identifiers for a song track on the iPod. One is an identifier unique to Apple's iTunes service and one is specific to that particular iPod device at the time (so the same song may have a different identifier on the same iPod at another time. One can get information about the song using the iPod specific identifier, but not through the usual way (i.e., the user navigating the menus). The base unit need only issue a command to the ipod device asking it for the number of tracks it has, then request the information to each track; but that information does not include the indices needed for playing a song or to know where it is in the menu system. In the future, such a music player may be designed with the capability of providing a unique identifier per song, usable to start play of the song, but there is still likely to be a need to support players of the type described above, for some years, as well.

To provide improved functionality, when an iPod music player or similar device is docked to the universal connector of the new entertainment unit described herein, the records defining the music content on the device (i.e., the metadata defining the content) are downloaded and a new database is created of that information. This database is created by first issuing to the music player a command to retrieve a list of all artists and writing that list to memory (e.g., RAM). Then for each artist so identified, the unit issues to the music player a command to retrieve a list of all of that artist's albums, which is likewise written to the memory. Then, for each album so identified, a command is issued to the player to retrieving a list of all songs thereon, and that list is written in memory. This creates a database wherein each song is uniquely identified and indexable by a combination of the artist/album/song names. For example, a data tree may be constructed with the list of artists at the top root level, the albums for each artist at the next level and the songs for each album at the third level. Once this data structure has been created in memory, it may be displayed on the display screen of the control unit. When a selection is made by a user, from that display, the path to the song is built automatically by virtue of the user's traversal of the tree. Then the song may be requested by the base unit as though it were being requested from the native user interface of the player, with a hierarchical address string. The database may be stored only in the base unit, only in the control unit, or in both of them. For example, the database may initially be created in memory in the base unit and then cloned to the control unit, if the latter has sufficient memory available, to reduce messaging traffic between the base unit and control unit and speed up the operation of accessing a song selection. This is in contrast to other approaches, such as “screen scraping,” wherein the screen contents of the music player are copied out to a remote control device and basically only screen coordinates are communicated back to the player when a selection is made on the control unit's screen. Such an approach may be slow and it does not allow for any enhanced functionality, such as jump button mapping to songs or groups of songs, to speed selection.

Thus, only metadata need be downloaded from the player and the player may then function as a service to the base unit or other device through which music can be played in response to making a song selection from the metadata.

With this approach, it is also possible to have the user's music library reside in a remote, networked location and to download and synchronize the corresponding metadata with the control unit, then to stream the music content when it is selected. The user's library may thus be a “virtual” library of music shared with others on a common server, the virtual library being only a list of songs, or a list supplemented by the metadata. If the former, the metadata content can also be common to others and downloaded whenever the user's “library” is synchronized.

Optionally, secondary indices may be written to permit quick access to, for example, the list of all albums (regardless of artist), all songs (regardless of album or is artist), and songs by artist (regardless of album).

Once this database exists in memory (e.g., memory 117) within the base unit, it also can be used to implement a variety of access features, including a “jump by spelling” feature, or to easily go from a song that is playing to the list of other songs in the same album or by the same artist or by the same name but by different artists. These access options are all straightforward database programming tasks as a song is now selectable by a path that can be communicated to the player. Then, once a song is selected to be played by any of these access features, the music player can be controlled via the user interface to serve up the selected song (e.g., by number in the database) and play it back through the base unit via a path address. Of course, it is also possible, technically, copyright law permitting, to download the song file into memory (semiconductor, hard drive or optical, for example) in the base unit and to play it from there, using an appropriate codec to turn the stored digital representation into an analog signal that can be supplied to transducers such as loudspeakers.

Any time the contents of the player are changed, of course, it is necessary to re-create the database of metadata in the base unit,

As shown, the interface module may also include a cover to protect the connector 514 when no ASM is docked.

### Additional Unified Interface Features

In some embodiments, buttons (whether physical or “soft” buttons on a touch screen) on the control unit may be user-assigned to content “presets,” also referred to as “Favorites,” for rapid recall by the user. For example, a button may be assigned to a song, to a radio station, or to an internet URL. In turn, the button assignments may be arrayed as a “band” and scanned sequentially by rotating the tuning knob. Thus, all Favorites are treated equally and agnostically with respect to their sources. They are simply entries in a list in a data structure, or the equivalent.

In some embodiments, in response to a user selecting a Favorite, the image displayed on the control unit's screen may be changed to incorporate content from the source of the Favorite. The use of a bitmapped screen allows the storage and display of any desired content that fits within the screen area. Such content may be pre-stored in a memory of the base unit or of the control unit, or it may be generated as needed. For example, art from an album cover may be reproduced as background, and text for the selection may be overlaid.

A benefit of the architecture set forth above is that the base unit can provide the supportive processing for the foregoing, transmitting to the control unit such information as is needed to generate the displays and receiving from the control unit the user's inputs. The sharing of processing burden between the base unit and the control unit can be divided according to the availability of processor resources, for optimum performance, or set statically. Thus, cost tradeoffs may be made with respect to the processor and memory provided in the control unit, without requiring architectural changes of any significant nature. Moreover, the majority of operations needed for assigning Favorites to buttons, rearranging the order of Favorites, and so forth may be accomplished on the control unit, via menu picks. Thus, the operations that require a computer to be connected to the base unit for managing configuration data are few. For example, adding a new content source may require configuring logon files for a subscription source such as an internet radio relay of a satellite content source. Establishing or managing such a new account is preferably done on a personal computer, and the resulting configuration and logon files then downloaded to the base unit (e.g., through a network port).

We note, also, as will now be apparent, that the control unit controls both functions of the base unit (e.g., volume) and also of the content source (e.g., satellite radio channel selection), whether the source is internal to the base unit (e.g., the tuner) or external (e.g., in accessed via an ASM or other interface).

### Hospitality Market Applications

With the addition of a networking module, the utility of the system can be greatly expanded in many ways. As the portable wireless (RF) control unit may be allowed to function largely as what is generally characterized as a “dumb” terminal (i.e., an input/output device with little additional computing functionality), via a network interface the combination of base unit and control unit may become the controller for numerous devices connected to the network (which may be the internet). Among the possibilities is to use the control unit in a hospitality (e.g., hotel) setting to provide not only “universal” remote control functions for a base unit as well as a television, video cassette recorder, DVD player, and other devices, but also a customizable unit which may be programmed according to a user's (i.e., guest's) immediate or stored preferences. The base unit may interact with and control these devices via any appropriate interface, such as an infrared transmitter, USB port or other communication mechanism. Moreover, when a user (e.g., traveler) arrives at a hotel equipped with the base unit, the user may dock a portable music player and have immediate access to his or her favorite music content. The portable music player may also be used as a general portable storage device to present a user preference file to the base unit. In turn, the base unit may communicate content from the preference file to any device networked with the base unit. This may include not only devices in the room, but also the management's computer system in the hotel, such as to make requests of record and to set the temperature for the room or to place an order for breakfast. In short, simply by docking a music player or other device (e.g., a USB memory “stick” or smart card), the user may register preferences with the base unit and have them communicated both within the room and within the extended environment. As a method for enhancing customer loyalty and the customer's experience, it is believed there is much merit in this approach.

Further, if the base unit is networked to the internet, either directly or via the hotel management's servers, a prospective guest may pre-arrange remote access to the guest's own home computer or network as a source of music or other data. The guest may also register preferences on the hotel management's server and have those preferences downloaded to the base unit in the guest's hotel room upon arrival. Such preferences might specify any of a large number of variables, including, without limitation, internet radio stations to be placed on a Favorites list and assigned pre-set buttons, alarm times and other alarm parameters, and possibly desired television programming.

It should be understood that the described user interface can present to a user a standardized interface for use in tabletop systems, automotive systems and even portable systems. The use of unified tuning; a bit-mapped graphics display and “soft”, programmable buttons; along with the described database features for accessing content from an ASM, all can be employed in those systems, together or in various groupings. The more features used in common, the more standard or unified the user interface becomes and the lower the cost of implementation. Adoption of a standard interface for automobile, home and/or office use, moreover, means the automobile driver is more likely to be able to operate the interface with minimal distraction, due to acquired familiarity and simplicity of interaction.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. For example, the base unit need not include a tuner at all; or it may only include a single band tuner. The base unit need not include an audio amplifier or loudspeakers; they could be in other housings. The base unit need not have the ability to receive portable music devices, network cards or the like. A system could be built wherein the control unit cannot be docked with the base unit and can only be a separate remote control. Or the control unit, when docked, might not have a direct electrical connection to the base unit; it might continue to use an RF link or it might use an infrared link or some other channel. The various features discussed above may be practiced singly or in any combination. Other variations will occur to the skilled artisan. Accordingly, the foregoing description and drawings are by way of example only.

What is claimed is:

1. A portable digital multimedia player remote controller unit arranged to store multimedia media file metadata used to wirelessly control a remote media server, comprising: a wireless network interface; a display device arranged to display a user interface having a number of user selectable items; and a processor unit that in response to a user selection of one of the user selectable items generates a signal that is wirelessly sent by the wireless network interface to the remote media server, the signal including multimedia file meta data identifying a multimedia file stored on the media server that, in turn, responds to the signals by accessing the identified multimedia file and once accessed, wirelessly sends the identified multimedia file to a remote media unit.

2. A portable digital multimedia player remote controller system arranged to store multimedia media file metadata used to wirelessly control a remote media server from a hand-held device, comprising: a hand-held unit having a wireless interface and a display device arranged to display a user interface presenting a number of user selectable items; a processor unit that in response to a user selection of one of the user selectable items (a) generates a signal that is transmitted to the remote media server, the signal including media file metadata identifying at least one media file stored on the media server and (b) receives and processes from the server the identified media file for playing to the user.

3. The system if claim 2 wherein the processor is in a unit separate from the hand-held unit and in wireless communication therewith.

4. A portable digital multimedia player remote controller unit arranged to store media file metadata used to wirelessly remote control a media server, comprising: a wireless network interface; a display device arranged to display a user interface having a number of user-selectable items; and a processor unit that in response to a user selection of one of the user-selectable items generates a signal that is wirelessly sent by the network interface to the media server, the control signal including information gleaned previously from the media file metadata identifying a media file stored on the media server that in turn, responds to the signals by accessing the identified multimedia file and once accessed, sends the identified media file to a player unit.

5. A method of accessing content stored on a digital content storage device on which one or more content records contain metadata defining content on the device, comprising:
a. downloading from the device to a controller at least some of said metadata;
b. storing said downloaded metadata in a database accessible to the controller; and
c. accessing content on the storage device from the controller using the database of downloaded metadata.

6. The method of claim 5 wherein the controller unit includes a portable, hand-held device.

7. The method of claim 5 or claim 6 wherein the database is in the controller unit.

8. The method of claim 7 wherein at least a portion of the database is in the handheld unit.

9. The method of claim 5 wherein the act (a) of downloading at least some of said metadata further includes:
i. issuing to the device a command to retrieve a list of all songs thereon, and
ii. writing the list of songs to the database so as to interrelate the songs to at least their albums,
whereby a database is created in which each song is uniquely identified.

10. The method of claim 9 wherein the act (a) of downloading at least some of said metadata further includes:
iii. issuing to the device a command to retrieve from the device a list of artists for whom content records are stored on the device,
iv. writing the list of artists to the database,
v. for each artist so identified, issuing to the device a command to retrieve a list of all of that artist's albums,
vi. writing the list of albums to the database so as to interrelate the artists to their albums,
vii. for each album so identified, interrelating the songs to their albums,
whereby a database is created in which each song is uniquely identified and accessible by a combination of the artist/album/song names.

11. The method of claim 10 wherein the database comprises a data structure in memory with the list of artists at a root level, the albums for each artist at the next level and the songs for each album at a third level.

12. The method of claim 11 further comprising displaying on a display screen of the controller unit said data structure, to allow a user to select content to be played.

13. The method of claim 12 further comprising, in response to user selection of content, the controller unit constructing an addressing path to the content automatically from the user's traversal of the data structure, and retrieving the selected content using the constructed addressing path.

14. The method of claim 5 in which accessing the selected content comprises streaming the selected content form the device to a player.

15. The method of claim 5 in which accessing the selected content occurs over a network.

16. The method of claim 5 wherein the controller unit controls the device via a network.
